(19) United States
(12) Patent Application Publication
(10) Pub. No.: US 2025/0290325 A1
(43) Pub. Date: Sep. 18, 2025

(54) BOX ENCLOSURE HOIST ASSEMBLY, BOX ENCLOSURE AND METHOD FOR CHANGING HOIST ASSEMBLY SPRING END ATTACHMENT POSITION

(71) Applicant: FAKRO PP SP. z. o. o., Nowy Sacz (PL)

(72) Inventors: Bartlomiej MOS, Nawojowa (PL); Jaroslaw WITOWSKI, Nowy Sacz (PL)

(73) Assignee: FAKRO PP SP. z. o. o., Nowy Sacz (PL)

(21) Appl. No.: 19/076,352

(22) Filed: Mar. 11, 2025

(30) Foreign Application Priority Data
Mar. 13, 2024 (PL) P.447992

(51) Int. Cl. E04F 11/06

(52) U.S. Cl. CPC E04F 11/066

(57) ABSTRACT

The subject-matter of the invention comprises a box enclosure hoist assembly, built out of spring (41), one end of which is designed to be connected to box enclosure fixed structural element (1) and the other end is connected with the hoist assembly hoist supports (42, 43) unit and there are at least two spring (41) end attachment positions (51, 52) on one of the supports (42) and that between attachment positions (51, 52) there is continuous traverse path (421) to guide spring (41) end from one attachment position (51) to another attachment position (52), as well as a method for changing spring end attachment position in the hoist assembly.

The subject-matter of the invention is a box enclosure hoist assembly, a box enclosure, in particular an attic stairs and a method for changing hoist assembly spring end attachment position.

Attic stairs with a spiral spring attached to stairs box using a hook and to scissor fitting comprising a supports using flat bar ridge have been disclosed under DE100673779A1. Spring force may be adjusted by changing the attachment position of the first support on the flat bar which features a few attachment openings. Spiral spring initial tension may also be adjusted by selecting an opening in the first support for connecting the second support. For that purpose, supports feature a few openings for a rotatable means of attachment between the two supports. This makes it possible to adjust the angle between supports, and thus also the angle between the first support and the closing hatch.

JPS55150200U disclose an attic stairs comprising a ladder, a box and a closing hatch as well as a fitting wherein said fitting comprising a supports and a spring connected to the attic stairs box and one of the supports. There are a few openings on that support which mark spring end attachment positions, chosen depending on the required spring tension.

There are known from JPS58137798U an attic stairs comprising a ladder, a box and a closing hatch as well as a fitting comprising a supports and a spring connected to the attic stairs box angle bar and one of the supports. The angle bar comprises a few openings, which are spring end attachment positions, chosen depending on the required spring tension.

In known state of the art, an adjusting box enclosure spring torque demands changing the attachment position of one end of the spring, carried out in stages which comprise detaching the spring and attaching it in a different position. This process requires the use of significant force in order to remove the spring from one attachment position and insert it into an adjacent position.

A box enclosure hoist assembly according to the invention solves this problem by using a continuous hoist assembly traverse path for the spring end, so that when changing the spring attachment position, its end skips between adjacent attachment positions whilst moving along the traverse path which connects attachment positions. Therefore there is no need to detach the spring from the assembly, which is more convenient and accomplished automatically.

The subject matter of the invention is a box enclosure hoist assembly, and attic stairs in particular, where said attic stairs comprising a fixed structural element and an articulated structural element, wherein the latter is suspended from the fixed structural element using the hoist assembly. That assembly is built out of a spring, one end of which is designed to be connected to the box enclosure fixed structural element and the other end is connected with the hoist assembly hoist supports unit. The supports unit together with the box enclosure hinge constitute a connector between the articulated structural element and the fixed structural element. The spring is used to relieve the articulated structural element in the box enclosure for each movement direction of that element relative to the fixed structural element, i.e. for attic stairs during their folding and unfolding. On one of the unit supports there are at least two spring end attachment positions, and between the attachment positions there is a continuous spring end traverse path from one attachment position to an adjacent position. The traverse path is a guide, preferably curved. The hoist supports unit is built out of two connected supports, referred to as the box support and the prop support. The box support in the box enclosure is attached to the box enclosure box inside wall, and the prop support is designed to be connected to the box enclosure articulated structural element and in particular box enclosure articulated structural element support beam. The traverse path may be located on the box support or the prop support. The hoist assembly is compatible with a box enclosure, and attic stairs in particular, which apart from the hoist assembly feature a fixed structural element in the form of a box, an articulated structural element in the form of a ladder with a closing hatch. One hoist assembly spring end is connected to a fitting attached in the box enclosure box. The said end is opposite to the spring end which is located in one of the available attachment positions on an appropriate support. Changing the spring end attachment position on a support is achieved according to the following method stages:
delivery of the box enclosure in a closed position, i.e. in a position where the closing hatch is in an essentially parallel position relative to the box enclosure box, and the spring end is located in the first attachment position of the support unit wherein said support unit comprises the traverse path,
disconnection of the box support from the prop support,
movement of the support unit with the traverse path and the spring end in first attachment position towards the hoist assembly spring,
automatic shift of the spring end along the traverse path from the first attachment position to the second attachment position,
connection of the box support to the prop support. The traverse path and attachment positions are located on the box support, or the traverse path and attachment positions are located on the prop support. When the supports are connected to each other, the spring end is located in one attachment position and does not travel along the traverse path, and a change to the spring end attachment position is possible when the supports are disconnected. After the box support has been disconnected from the prop support, spring end is located in a temporary position and its movement is blocked in the guide, preferably using a traverse path blocking step, wherein the spring end can leave the temporary position after the support with traverse guide has moved towards the spring and the spring end jumps over the traverse path blocking step.

If the box enclosure is subject to an upgrade, for example the weight of the articulated structural element increases, then in order to ensure it is guided in a controlled manner during use, the spring torque should be adapted to the changed working conditions. Changing the torque does not entail replacing the spring but changing its attachment position to increase the spring force arm length, which balances the resultant torque of the box enclosure articulated elements acting along the prop support.

The solution is depicted on the drawing, with given figures showing the following:

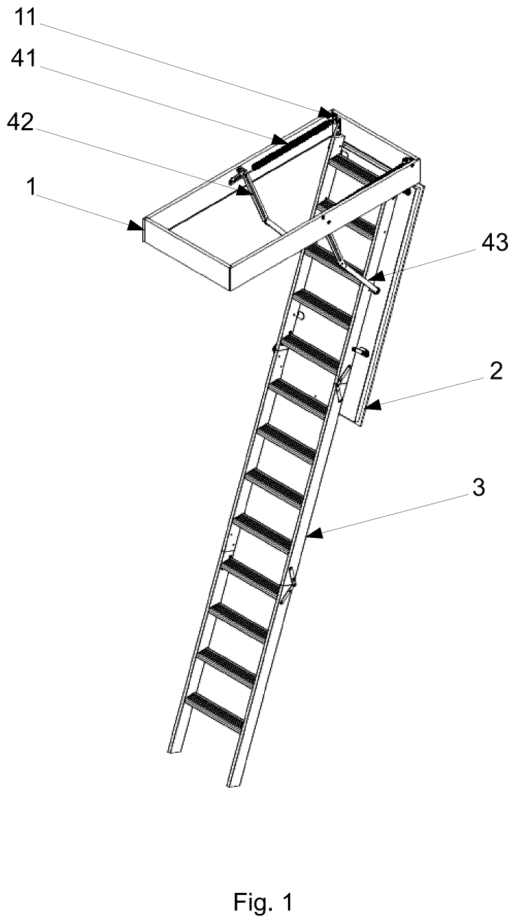

FIG. 1 spatial view of box enclosure in the form of attic stairs in an unfolded position,

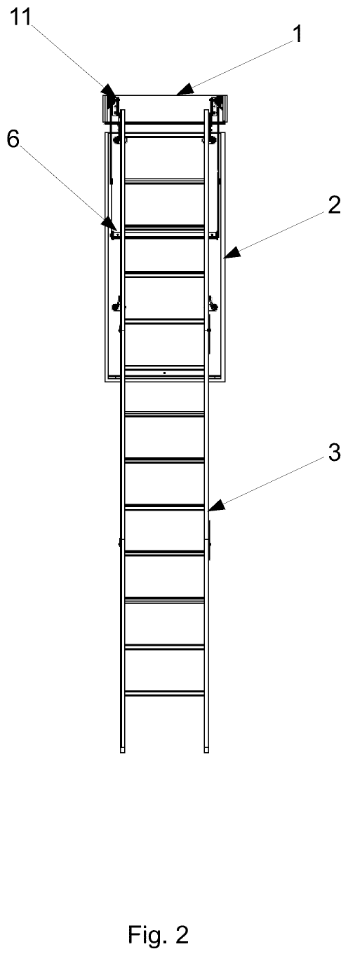

FIG. 2 front view of box enclosure in the form of attic stairs in an unfolded position,

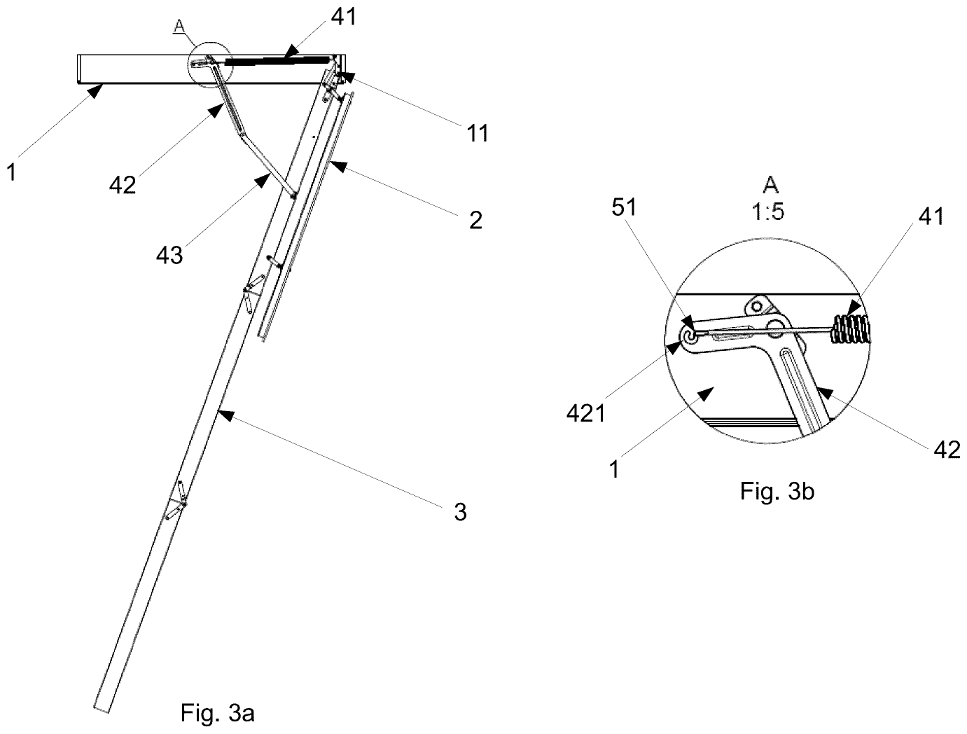

FIG. 3a side view of box enclosure in the form of attic stairs in the first unfolded position,

FIG. 3b enlarged view of attic stairs spring attachment position,

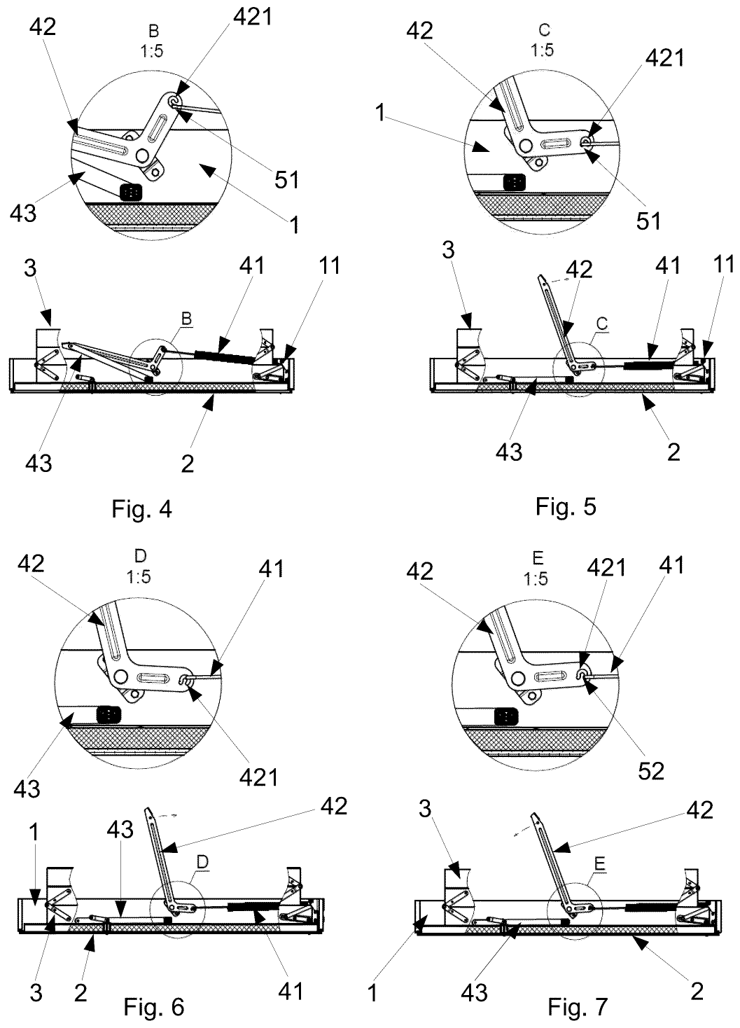

FIG. 4 box enclosure in the form of attic stairs in a folded position and enlarged view of the first attachment position,

FIG. 5 box enclosure in the form of attic stairs in a folded position after box support and prop support have been disconnected and enlarged view of the first attachment position,

FIG. 6 box enclosure in the form of attic stairs in a folded position after the box support has travelled towards the spring and enlarged view of the intermediate attachment position between the first and second attachment positions,

FIG. 7 box enclosure in the form of attic stairs in a folded position after the box support has travelled towards the spring and enlarged view of the second attachment position,

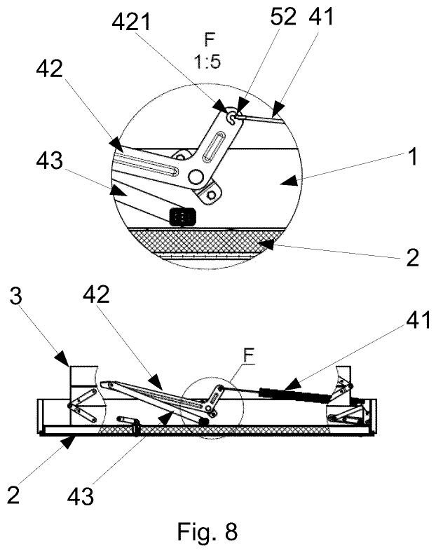

FIG. 8 box enclosure in the form of attic stairs in a folded position after the box support and the prop support have been connected and enlarged view of the second attachment position,

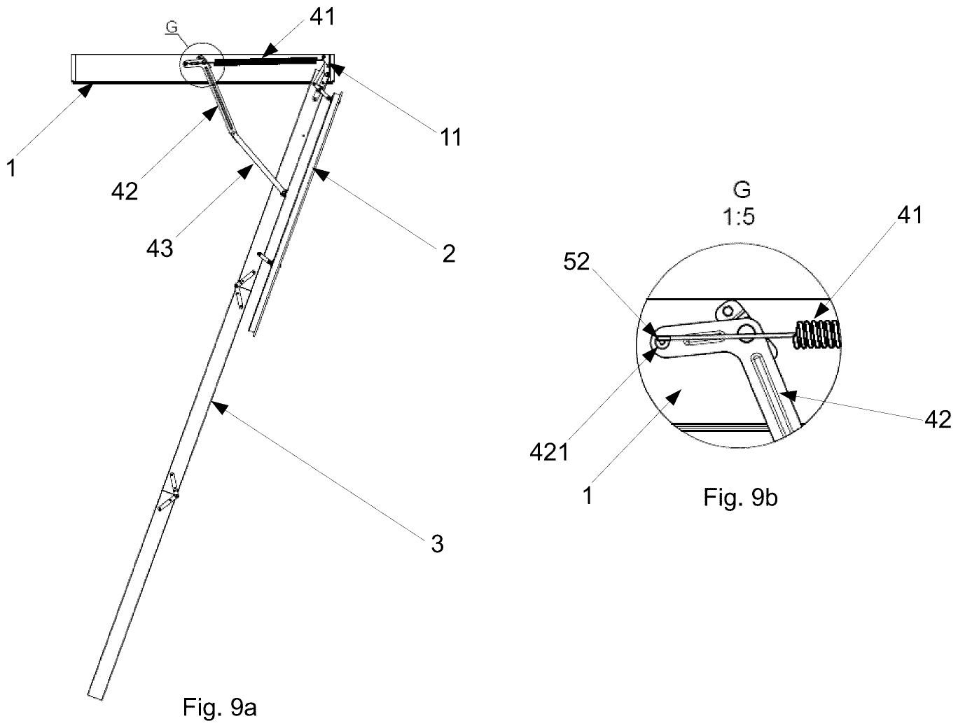

FIG. 9a side view of box enclosure in the form of attic stairs in an unfolded position,

FIG. 9b enlarged view of attic stairs spring second attachment position.

An embodiment shall be presented for a box enclosure hoist assembly in the form of attic stairs, built out of a fixed structural element, or box 1 and articulated structural elements in the form of closing hatch 2 and stairs ladder 3. The attic stairs feature a hoist assembly built out of spring 41, one end of which is connected to box 1 angle bar 11 and the other end is located in first attachment position 51 on support unit box support 42, wherein that unit also features second prop support 43. Both supports are detachably connected to each other. Traverse path 421 for continuous guiding the spring end inside it towards the target attachment position is located between first and second attachment positions 51, 52, on box support 42. To change spring end attachment position to second attachment position 52, in attic stairs folded position, disconnect box support 42 from prop support 43, tilt box support 42 towards box 1 angle bar 11, which will reduce spring 41 tension, in such a manner that spring end automatically shifts from first attachment position 51 to second attachment position 52. Then box support 42 connects once again with prop support 43, whose other end is connected to ladder 3 support beam 6.

The second embodiment differs from the first embodiment in that the spring end attachment positions are located on prop support.

1. A box enclosure hoist assembly, comprising a spring, where one end of the spring is arranged to be connected to a box enclosure fixed structural element and the other end is connected to a supports unit of the hoist assembly characterized in that the supports unit comprising at least two spring end attachment positions and that between the attachment positions there is a continuous traverse path arranged to guide spring end from one attachment position to another attachment position.

2. The box enclosure hoist assembly according to claim 1 characterized in that the traverse path is a guide, with spring end attachment positions located at the guide ends.

3. The box enclosure hoist assembly according to claim 1 characterized in that the supports unit comprising two supports connected one to another, referred to as box support and prop support.

4. The box enclosure hoist assembly according to claim 3 characterized in that traverse path is located on box support.

5. The box enclosure hoist assembly according to claim 3 characterized in that the traverse path is located on the prop support.

6. The box enclosure hoist assembly according to claim 3 characterized in that the prop support is arranged to be connected to box enclosure articulated structural element.

7. A box enclosure and in particular attic stairs comprising
the hoist assembly according to claim 1 and
the fixed structural element, preferably in the form of a box,
the articulated structural element, preferably in the form of ladder with closing hatch, characterized in that a support unit is attached to the box enclosure box inner wall and a prop support is connected to a box enclosure ladder support beam.

8. The box enclosure according to claim 7 characterized in that one spring end is connected to a fitting attached to the box enclosure box.

9. A method for changing spring end attachment position in the box enclosure according to claim 7 wherein said spring is an element of a hoist assembly, wherein the hoist assembly comprises a spring, where one end of the spring is arranged to be connected to a box enclosure fixed structural element and the other end is connected to a supports unit of the hoist assembly characterized in that the supports unit comprising at least two spring end attachment positions and that between the attachment positions there is a continuous traverse path arranged to guide spring end from one attachment position to another attachment position,
characterized in that the method comprising following stages:
delivery of the box enclosure in a closed position, i.e. in a position where the closing hatch is in an essentially parallel position relative to the box enclosure box, and the spring end is located in the first attachment position of the support unit wherein said support unit comprises the traverse path,
disconnection of the box support from the prop support,
movement of the support unit with the traverse path and the spring end in first attachment position towards the hoist assembly spring,
automatic shift of the spring end along the traverse path from the first attachment position to the second attachment position,
connection of the box support to the prop support.

10. The method according to claim 9 characterized in that the traverse path and the attachment positions are located on the box support.

11. The method according to claim 9 characterized in that the traverse path and the attachment positions are located on the prop support.

12. The method according to claim 9 characterized in that when supports are connected to each other, the spring other end remains in one attachment position and does not move along the traverse path.

13. The method according to claim 9 characterized in that changing the spring end attachment position is possible when the box and the prop supports are disconnected.

14. The method according to claim 9 characterized in that after the box support has been disconnected from the prop support, the spring end is located in a temporary position and its movement is blocked in the guide, preferably using a traverse path blocking step, wherein the spring end can leave the temporary position after the support unit with the traverse guide has moved towards spring and the spring end jumps over the traverse path blocking step.
